(19) United States
(12) Patent Application Publication
(10) Pub. No.: US 2009/0038004 A1
(43) Pub. Date: Feb. 5, 2009

(54) ROLE CHANGE BASED ON COUPLING OR DOCKING OF INFORMATION HANDLING APPARATUS AND METHOD FOR SAME

(76) Inventor: Gabor Blasko, Budapest (HU)

Correspondence Address: DAVID AKER, 23 SOUTHERN ROAD, HARTSDALE, NY, 10530, US

(21) Appl. No.: 11/831,842

(22) Filed: Jul. 31, 2007

(51) Int. Cl. H04L 9/32

(52) U.S. Cl. 726/20

(57) ABSTRACT

An information handling system, comprising an information handling device containing memory for information specific to a particular role or function to be performed by a user of the device, having a display for displaying a portion of the information and functional portions for manipulating the information; and apparatus for coupling to the device, the apparatus being associated with a user of the device and containing information concerning identity and preferences of the user of the device. The apparatus acts a dock for receiving the device. A method comprising loading information from the apparatus to which the device is coupled so as to customize operation of the device. Information can include at least one of preferences, settings, authorization rights, security codes and programs preferred by a user of the apparatus. Role of the device may change in response to communications hardware for receiving signals indicative of location of the device, which changes roles based on the signals.

### BACKGROUND OF THE INVENTION

1. Field of the Invention

This invention relates to information handling systems, and in particular to information handling systems that me be associated with or worn on the body and to methods for use of such systems. More specifically, it relates to those apparatus which may be worn on the body wherein the wearer or user must assume different roles.

2. Background Art

Body worn devices are a very personal and often very customizable for the person using them. There are often environments where the users assume different roles, and each role has an associated wearable device associated with it (e.g. pagers). When users change roles, they cease using one device, which they may pass on to someone else and may start using another, which can have a different set of applications and a different set of customizable features. The device may support the user selecting different profiles, but on some devices this might not be possible due to the limitations of the device (e.g. memory storage needed to store profiles).

A device may also need to be associated with a particular role, and passed from one user to another, which users, in succession, take on the role, as for example, when successive shifts of personnel are needed to perform a task or set of tasks on an around-the-clock basis. An example of such applications is a hospital ward or floor, where a series of physicians or nurses is responsible for patient care. When a shift ends, it is necessary for all of the information associated with the role of the physician on duty or the nurse on duty, to be efficiently passed to the person on the next shift, without loss of important information. While conferences between departing personnel and newly arriving personnel should not be discouraged, it is difficult for them to pass on to the next person all pertinent data in a short period of time.

There are countless other examples of situations wherein data must be passed to from one person to another, so that the specific role can be assumed by the new person. A short, but by no means complete list includes a security supervisor, a production manager, a manager of a group of workers, a manager of a sports team, a military commander, a construction manager, a stockbroker and a salesperson. In cases where a desktop computer is available, this may be a relatively straightforward task. However, there are many situations wherein mobility requirements, and exigent circumstances, do not permit access to a desk-top computer. It is necessary for a mobile worker, professional or manager to have the information at his or her fingertips, in a very small and light-weight device, and available for immediate use.

### SUMMARY OF THE INVENTION

It is an object of the invention to provide a system which allows a worker, professional or manager who must assume a role to have up to date information, applications, privileges to download or stream information, and access to locations necessary to assume such role.

It is a further object of the invention to provide a system having computer capabilities to assist the worker, professional or manager in a role.

It is another object of the invention to provide a wearable system having these attributes.

The wearable system in accordance with the invention includes a device that has a set of applications (or application modules). Additionally, the device may have customizable settings for each specific user. These can include the mapping of input to functionality, possible shortcuts to accessing functionality quicker, preferences for the visualization of information, and preferences for notification method (beep vs. vibrator)

The wearable device is mounted on the body in a personal docking enclosure, so that the computing device can be removed from the personal docking enclosure and given to another user when a user passes on a role. The docking enclosure or apparatus contains one or more duplicate components of the dockable device itself such as storage, input, and display facilities. While the dockable device may have a small touch screen display, the docking apparatus itself may include a small laser projector that acts as a secondary display for the docked device. Upon docking the docked device loads the preferences/profile (and possibly stored applications) of the user from the personal dock's memory. The docking enclosure contains self-identification circuitry: Upon docking the dock identifies itself to the docked device, which initiates a role swapping procedure on the device.

Role swapping may include one or more of the following:

Input method changes: mapping of input (buttons, gestures on the touch screen, to functionality (shortcuts to functions, execution of commands, input of data).

Display method changes: modification of the manner in which information is displayed (e.g. larger fonts, layout of items on the screen, adjustment of speaker volume settings, appearance of on screen items (e.g. analog vs. digital clock).

Change in the set of applications (or application modules) on the device. For example, locally stored but inaccessible applications might become accessible.

Applications stored in the personal dock may be transferred to the device. Applications that are not needed by the role can be removed from the device's memory.

The computing device can have a method of accessing a computer network (e.g. wireless connection or plugging into an apparatus connected to a network, or connecting to a computer on a network), applications which are neither stored on the device, nor stored on the personal docking apparatus may be downloaded into the device from a remote source.

If an application is missing a module, or needs a module upgrade, that can also be accomplished upon docking.

### Change in Authorizations.

Upon assuming a role, the decision-making capabilities and responsibilities of the user may change. Functionality that is available in the device and/or the application that requires special authority may be automatically unlocked upon docking. Other security measures can be used as well.

These objects and others are achieved in accordance with the invention by an information handling system, comprising an information handling device containing memory for information specific to a particular role or function to be performed by a user of the device, the device having a display for displaying a portion of the information and functional portions for manipulating the information; and apparatus for coupling to the device, the apparatus being associated with a user of the device and containing information concerning identity and preferences of the user of the device. The apparatus acts a dock for receiving the device. Information is exchanged between the device and the apparatus by one of direct electrical connection, a radio link and an infrared link. The apparatus is wearable upon a user of the apparatus.

The apparatus includes software modules for use by a wearer of the apparatus. The device and the apparatus include software transfer means for transferring software modules from the apparatus to the device or between the apparatus and the device.

The software modules are for use in the particular role or function to be performed by a user of the device

The role is one of a medical practitioner attending to a group of patients; a security supervisor; a production manager; a manager of a group of workers; a manager of a sports team; a military commander; a construction manager; a stockbroker; and a salesperson.

The device presents an identity challenge to a user when the device is coupled to the apparatus. The identity challenge comprises at least one of a password, a fingerprint, gestures, face recognition and voice recognition.

The system can further comprise an update module to which the device can be coupled for at least one of maintenance and updating when the device is not coupled to the apparatus.

The apparatus is wearable by a user of the apparatus on one of a wrist, belt, clothing or clothing accessory, or in a pocket of a user.

The invention is also directed to a method for transferring a role from a first person to a second person, comprising storing in an information handling device, information and program data pertinent to the role; and passing the device from the first person to the second person by terminating communication between the device and an apparatus worn by the first person, and establishing communication between the device and an apparatus worn by the second person.

The method can further comprise providing a challenge to the identity of each person using an apparatus to which the device is coupled.

The method can further comprise loading information from an apparatus to which the device is coupled so as to customize operation of the device.

The information can include at least one of preferences, settings, authorization rights, security codes and programs preferred by a user of the apparatus.

In accordance with the method, the role can be, but is not limited to, one of a medical practitioner attending to a group of patients; a security supervisor; a production manager; a manager of a group of workers; a manager of a sports team; a military commander; a construction manager; a stockbroker; and a salesperson.

In accordance with another aspect the invention is also directed to an apparatus comprising an information handling device containing memory for information specific to a particular role or function to be performed by a user of the device, the device having a display for displaying a portion of the information and functional portions for manipulating the information; and communications hardware for receiving signals indicative of the location of the device, the device changing roles based on the signals.

### BRIEF DESCRIPTION OF THE DRAWINGS

The foregoing aspects and other features of the present invention are explained in the following description, taken in connection with the accompanying drawings, wherein:

FIG. 1 is a perspective view of a system in accordance with the invention, with the two major components separated from one another.

FIG. 2 is a perspective view of a system in accordance with the invention, with the two major components physically connected to one another.

FIG. 3 is a plan view of a master docking station with provisions for receiving one of the major components of the system of FIG. 1 and FIG. 2.

FIG. 4 is a block diagram of one of the components of the system of FIG. 1 and FIG. 2.

FIG. 5 is a block diagram of the other of the components of the system of FIG. 1 and FIG. 2.

### DETAILED DESCRIPTION OF THE PREFERRED EMBODIMENT

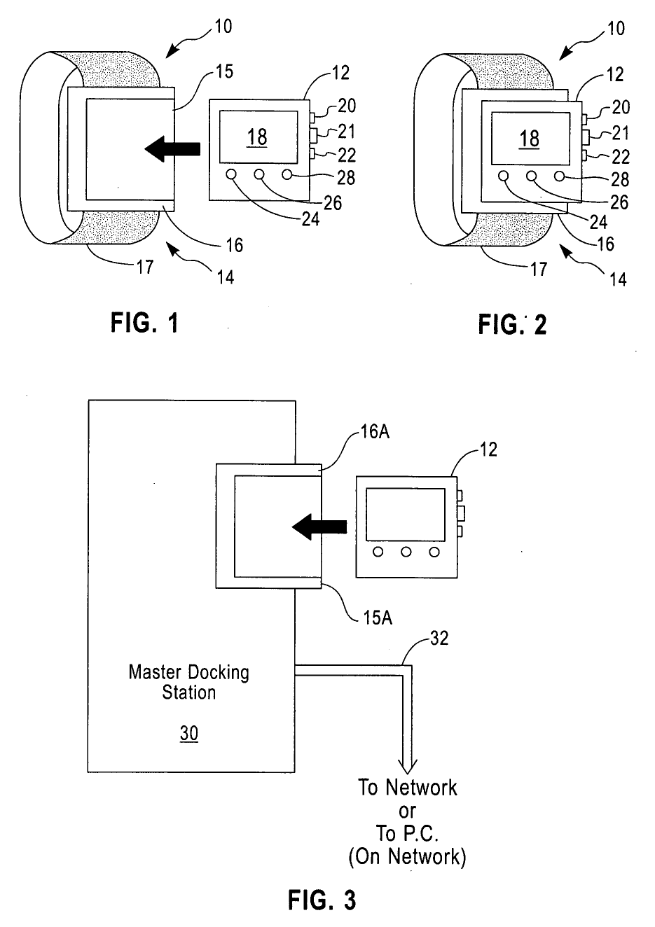

Referring to FIG. 1 and FIG. 2, there are shown perspective views of a system 10 in accordance with an embodiment of the invention. Although the present invention will be described with reference to the embodiment shown in the drawings, it should be understood that the present invention can be embodied in many alternate forms of embodiments. In addition, any suitable size, shape or type of elements or modules could be used.

The system 10 includes a data processing device 12 and an apparatus 14, which serves as a docking station for device 12, as is shown in FIG. 2. Apparatus 14, as more fully described below, also includes data processing capability, and may be configured so as to be worn by a user, by using a strap or fabric fastener, or on a belt or in a pocket, or integrated into clothing or a clothing accessory in some manner, and available or retrieved therefrom for use. However, preferably, as shown in the illustrated embodiment, apparatus 14 is configured with a holder 15 having a lip 16 extending about three of its sides. Holder 15 is configured to removeably and securely accept device 12, and serves as a docking station for device 12. Apparatus 14 also includes a wrist strap 17, so that the combination of device 12 and apparatus 14 form a system that looks very much like a wristwatch. In fact, preferably, the combination forms a wristwatch computer.

Device 12 has a display screen 18, which may serve as a touch screen for gestures made with a finger or a stylus, side buttons 20, 21 and 22, which can be used in a manner similar to those on a watch, and a series of functional buttons 24, 26 and 28, which may be programmed to function in a manner similar to functional keys on a computer keyboard. Display 18 may have a periphery with sensors disposed about the periphery for entering data and commands using gestural inputs, as described in U.S. patent application Ser. No. 10/977,322, entitled Input Method and Apparatus Using Tactile Guidance and Bi-directional Segmented Stroke, which is incorporated herein, in its entirety.

Upon docking, the docked device 10, sensing that it has been docked, may pose a challenge to see if the user who is wearing the personal docking apparatus 14 is authorized to use the personal docking apparatus 14 and is therefore authorized to have a docked device 12 with the specific role. The challenge may be any one of a password, a fingerprint, gestures (on touch screen display screen 18), face recognition and voice recognition. Device 12 or apparatus 14, or both may be configured with appropriate hardware (an identification sensor) such as a small fingerprint scanner, a miniature video camera or a microphone to facilitate response to such challenge. For example, apparatus 14 can have in memory a template of the user's fingerprint, in a manner similar to that of a smartcard, and the device 12 can have the fingerprint sensor on it. If the fingerprint sensed by the sensor on the device 12 matches the template stored in the memory of apparatus 14, identification is successful.

The challenge may also be met by entering a sequence of button presses, either with physical buttons, such as buttons 24, 26 and 28 or with the help of virtual buttons either on a touch sensitive surface of display 18, or gestures on touch sensors on the bezel or frame of display 18. Device 12 may also have inertial sensors (e.g. magnetometers, gyroscopes) which enables it to sense that it is being moved. Thus, “gesturing” may also include waving a wrist worn device in space, according to some pattern (for example, drawing in circle or a cross in mid-air).

The apparatus 14 may identify itself to the device 12 in any one of several different ways. Mating metal contacts or wires (not shown) associated with the back of device 12 and a corresponding part of holder 15 may be used to transmit electrical signals. Alternatively, identification may be accomplished without requiring physical contact, such as by apparatus 14 having an RF-ID tag which emits a radio signal for identification purposes if device 12 is within close proximity. Both apparatus 14 and device 12 may each be equipped with radio frequency communication capabilities (for example BlueTooth® technology), and discover the presence of each other. Yet another possibility is for apparatus 14 and device 12 to each be equipped with an infrared transceiver unit (not shown). Communication and discovery may be initiated using an IrDA standard. The sensor of the infrared transceiver of apparatus 14 may be positioned in holder 15, or covered with a sliding cover (not shown) so as to be physically inaccessible from the outside, and only accessible if a device 12 physically docks in apparatus 14.

Referring to FIG. 3, device 12 may be received within the lip 16A of a holder 15A of a master docking station 30. Station 30 may be connected to a computer network, or to a computer, such as a personal computer (not shown) on a network, by a suitable network cable 32. Alternatively, a wireless connection may be used between master docking station 30 and a network interface device (not shown). Docking of device 12 in master docking station 30 can be used for the purpose of updating various software modules stored for use in memory of device 12, including application programs, or for providing new application programs. In addition data peculiar to the role of device 12 may be loaded into the memory of device 12. For example, if device 12 is used by a doctor covering a hospital ward, identification and medical data for a new patient just admitted to the ward may be loaded into memory of device 12. It will be understood that in the case of medical, or other sensitive data, suitable precautions are taken to assure confidentiality, such as specific encoding and/or password protection of the data.

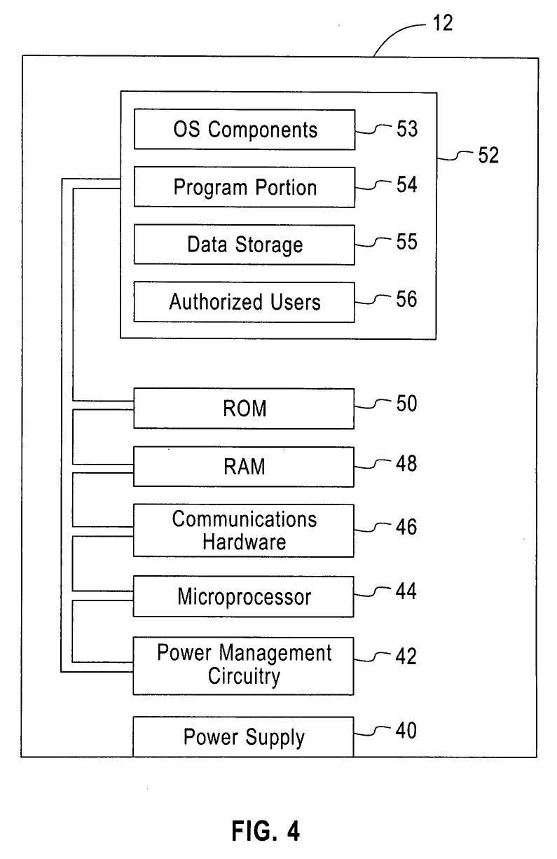

Referring to FIG. 4, device 12 is configured with hardware components including disposable batteries or a rechargeable power supply 40 (and suitable recharging means, as well known in the art), power management circuitry to conserve power 42, a microprocessor 44, communications hardware 46 (as more fully described above with respect to FIG. 1 and FIG. 2) for communicating with apparatus 14 or master docking station 30, RAM storage 48 for running applications, ROM 50 (permanent storage), and a flash memory 52 (or other erasable memory) for semi-permanent storage. The flash memory 52 contains general operating system like components 53, such as software components such those used to display data, on display 18 of device 12, those used to assist in the entering, editing and deleting of data from device 10, including the programming of functional buttons 24, 26 and 28, and those used for processing gestural inputs if appropriate peripheral sensors are provided on display 18 of device 12. The flash memory 52 also contains a program portion 54 for storing major application programs used by device 12. These programs include software modules for program and data updating.

The flash memory 52 also contains a data storage portion 55, for containing data pertinent to the role of device 12. In the case of a medical facility, such as a hospital ward, provisions are made, for each patient, to store patient personal and identification data, including possibly a facial photograph, medical history, such as drug and other allergies, and information on vital signs as a function of time, as may be found on a typical hospital chart. Other information that is stored, in the case of a medical facility, may include which specific drugs are available in the hospital pharmacy, and what medical equipment is available to perform specific medical tests. Finally, an authorized user portion 56 of memory 52 is made available to store a list of authorized users of device 12 (i.e. which of a series of apparatus 14 is authorized to work with device 12) and the proper answers to the challenges to the identity of such users, as more fully described above.

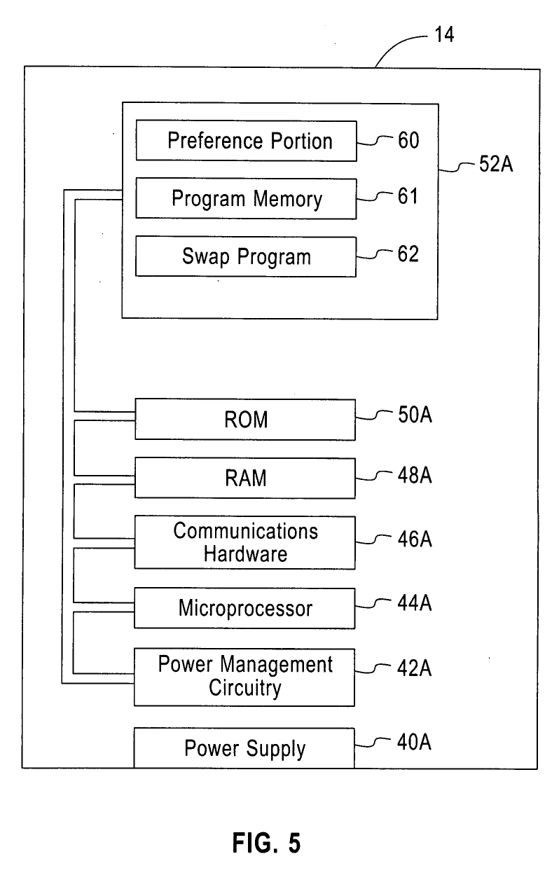

Referring to FIG. 5, apparatus 14 has all of the same type of hardware components as device 12. These components are referred to by the same reference numeral as in FIG. 4, but with a suffix of “A”. However, the software components stored in flash memory 52A are different. There is a preference memory portion 60 for storing the display gestures, user relevant profile, authorization data, user-interface and user interaction preferences, and any other preferences of the user who uses apparatus 14. An application program memory 61 stores specific programs of use to the user of apparatus 14. These programs are uploaded to a device 12, when a device 12 is coupled to apparatus 14 for communication via communications hardware 46A. To make room in the memory of device 10, some of the application programs therein may be temporarily off-loaded to apparatus 14. Before terminating communication between device 12 and apparatus 14, the programs are returned to the place where they are normally stored by another program interchange or “swap”, as facilitated by a swap program 62.

In some embodiments, if the dockable device 12 and the apparatus 14 are electrically connected so as to be physically on a same data bus, then no ‘uploading’ is needed, because the apparatus 14, and the device 12 can intelligently share information. Further, the device 12 can store the data on the apparatus 14 as it's own data. Thus, “uploading” from apparatus 14 may allow apparatus 14 to serve as external intelligent storage (for example, in a manner analogous to a file server, that does authorization checks)

It will be understood that device 12 may also serve other functions. For example, it may be undocked from an apparatus 14 worn by a user, and inserted into a docking station used to provide access to a secure facility. As in the case with coupling or docking to apparatus 14, an identity challenge may be provided to the person using device 12 in this way. In this case the information contained in device 12, which may include a portion of the information needed to meet the identity challenge (the other portion being provided by the person) can be encrypted in a form that is particularly difficult to decode.

In accordance with another aspect of the invention, a role is associated with a location of device 10. The role change is a result of or is triggered by the user entering with the 10 device into an environment which may be identified based on radio signals detected by communications hardware 46 (FIG. 4) of device 12.

Thus, the role change (for example, providing access to restricted information, or triggering the activation of an application, or the downloading of data and/or application onto device 12) may be triggered by an external event (for example, detection by apparatus 14, or detection by device 12 that the environment has changed (e.g. going from one Wi-Fi network into another).

The present invention advantageously provides the opportunity for a worker, professional or manager to utilize a device associated with a particular role, and to have that device customized automatically with the user's preferences, in terms of settings, programs, type of display, etc. when the device is coupled to or docked with the user's personal apparatus, which may be worn on the body of the user for quick and convenient access when the user is mobile and when and if exigent circumstances exist.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. An information handling system, comprising:
an information handling device containing memory for information specific to a particular role or function to be performed by a user of said device, said device having a display for displaying a portion of said information and functional portions for manipulating said information; and
apparatus for coupling to said device, said apparatus being associated with a user of said device and containing information concerning identity and preferences of said user of said device.

2. The system of claim 1, wherein said apparatus acts a dock for receiving said device.

3. The system of claim 1, wherein information is exchanged between said device and said apparatus by one of direct electrical connection, a radio link and an infrared link.

4. The system of claim 1, wherein said apparatus is wearable upon a user of said apparatus.

5. The system of claim 1, wherein said apparatus includes software modules for use by a wearer of said apparatus.

6. The system of claim 6, wherein said device and said apparatus include software transfer means for transferring software modules from said apparatus to said device.

7. The system of claim 6, wherein said device and said apparatus include software transfer means for transferring software modules between said apparatus and said device.

8. The system of claim 5, wherein the software modules are for use in the particular role or function to be performed by a user of said device

9. The system of claim 5, wherein said role is one of:
a medical practitioner attending to a group of patients; a security supervisor; a production manager; a manager of a group of workers; a manager of a sports team; a military commander; a construction manager; a stockbroker; and a salesperson.

10. The system of claim 1, wherein said device presents an identity challenge to a user when said device is coupled to said apparatus.

11. The system of claim 1, wherein said identity challenge comprises at least one of a password, a fingerprint, gestures, face recognition and voice recognition.

12. The system of claim 1, further comprising an update module to which said device can be coupled for at least one of maintenance and updating when said device is not coupled to said apparatus.

13. The system of claim 1, wherein said apparatus is wearable by a user of said apparatus.

14. The system of claim 11, wherein said apparatus is wearable on one of a wrist, belt, clothing or clothing accessory, and in a pocket of a user.

15. A method for transferring a role from a first person to a second person, comprising:
storing in an information handling device, information and program data pertinent to said role; and
passing the device from the first person to the second person by terminating communication between the device and an apparatus worn by the first person, and establishing communication between the device and an apparatus worn by the second person.

16. The method of claim 15, further comprising providing a challenge to the identity of each person using an apparatus to which said device is coupled.

17. The method of claim 15, further comprising loading information from an apparatus to which said device is coupled so as to customize operation of said device.

18. The method of claim 17, wherein said information includes at least one of preferences, settings, authorization rights, security codes and programs preferred by a user of said apparatus.

19. The method of claim 15, wherein the role is one of:
a medical practitioner attending to a group of patients; a security supervisor; a production manager; a manager of a group of workers; a manager of a sports team; a military commander; a construction manager; a stockbroker; and a salesperson.

20. An apparatus comprising:
an information handling device containing memory for information specific to a particular role or function to be performed by a user of said device, said device having a display for displaying a portion of said information and functional portions for manipulating said information; and
communications hardware for receiving signals indicative of the location of said device, said device changing roles based on said signals.
